(19) United States
(12) Patent Application Publication
(10) Pub. No.: US 2022/0134674 A1
(43) Pub. Date: May 5, 2022

(54) Generation Of Modified Model Data For Three Dimensional Printers

(71) Applicant: Hewlett-Packard Development Company, L.P., Spring, TX (US)

(72) Inventors: Jordi Roca Vila, Sant Cugat del Valles (ES); Jordi Sanroma Garrit, Sant Cugat del Valles (ES); Xavier Gasso Puchal, Sant Cugat del Valles (ES)

(73) Assignee: Hewlett-Packard Development Company, L.P., Spring, TX (US)

(21) Appl. No.: 17/418,789

(22) PCT Filed: Jul. 9, 2019
(86) PCT No.: PCT/US2019/040994

§ 371 Date: Jun. 26, 2021

(51) Int. Cl. B29C 64/393; B29C 64/40; B29C 64/188; B33Y 40/20; B33Y 50/02

(52) U.S. Cl. CPC B29C 64/393; B29C 64/40; B33Y 50/02; B33Y 40/20; B29C 64/188

(57) ABSTRACT

Object model data is obtained, defining an object to be generated by a three-dimensional printer. A frame is determined, suitable for supporting the object during post-processing of the generated object. Printer control data is generated comprising build data to control a three-dimensional printer to generate the object and the frame.

### BACKGROUND

Following a build operation to generate one or more printed parts in a three-dimensional (3D) printer, the printed parts may be subjected to post-processing steps such as chemical polishing. In order to carry out such post-processing steps, an operator may remove printed parts from a build chamber and transfer them to a post-processing chamber, such as a chemical polishing chamber.

### BRIEF DESCRIPTION OF THE DRAWINGS

FIG. 1 shows schematically an example of a 3D build comprising a printed object surrounded by a supporting frame.

FIG. 2 shows an example of a printed object and surrounding frame, including branches connecting the object to the frame.

FIG. 3 shows an example of a branch for connecting an object to a frame.

FIG. 4 is a flowchart showing an example of a method for generating modified model data.

FIG. 5 is a flowchart showing a further example of a method for generating modified model data.

FIG. 6 shows an example controller configured to generate modified model data.

FIG. 7 shows an example of a computer readable medium comprising instructions to generate modified model data.

### DETAILED DESCRIPTION

After the completion of the build operation in a 3D printer or other additive manufacturing system, printed parts may undergo post-processing steps in order to finish the parts to a particular specification. For example, in powder-based 3D printing processes, post-processing may include sandblasting of the printed parts to remove remaining powder on the part. Post-processing may also, for example, include chemical polishing of the printed parts to remove surface layering and achieve a high level of surface smoothness. Such post-processing steps may be conducted by an operator removing the printed parts from the build chamber of the 3D printer, and transferring them to a post-processing chamber. The operator may load individual printed parts onto a support structure which is housed within the post-processing chamber during the post-processing step.

The present disclosure describes how a supporting frame may be determined, that is suitable for supporting the part(s) during post-processing, and how modified model data is generated representing both the object and the frame. The provision of the supporting frame may facilitate the handling of the printed object by an operator, for example when transferring the printed object, for example from the build unit, for example to a post-processing apparatus. In particular, where the build operation generates a plurality of individual parts, a printed frame that supports all of these parts may enable an operator to easily transfer all parts from the build unit for post-processing by handling the frame, rather than handling each part individually, and may also allow for ease of subsequent removal of the parts from the post-processing apparatus. In this case, the frame may also serve to maintain a separation between individual parts during post-processing, thereby preventing individual parts from coming into contact and, for example, fusing together during chemical polishing.

The frame may be arranged to envelop the part(s), which may protect the parts when being handled by an operator, for example during transfer to a post-processing chamber, by enabling the frame to be simply placed in the chamber, without the need to load individual parts onto a separate support structure. In this example, the frame may be arranged such that a portion of the frame extends beyond the object on all sides, such that the object will be supported by a portion of the frame when placed on a surface in any orientation.

The present disclosure describes how, during a pre-print procedure, object model data defining an object to be printed may be used to determine such a supporting frame and generate modified model data representing both the object and the supporting frame.

In an example of the disclosure, the process of producing a 3D-printed object to a particular specification may include: (i) part and build preparation; (ii) 3D printing; and (iii) post-processing. During the part and build preparation, a digital model of each object to be printed, comprising object model data representing the object, may be generated or received by a pre-print application. A supporting frame may then be determined around the object(s) to be printed, wherein the frame may be determined in accordance with a number of criteria, as described below. Parameters specifying the size and location of the frame may be determined manually by a user, or automatically in the pre-print application. In some examples, parameters may be specified by a combination of manual and automatic processes, for example by the pre-print application generating a proposed frame structure which may then be accepted, rejected or modified by the user. Automatic determination of the frame structure may utilise machine learning techniques. Digital models of objects to be printed, and associated supporting frame(s), may be packed into the available build volume, either manually or using an automated packing algorithm, and such packing may be selected to minimise build height in order to maximise the efficiency of the build process. Modified model data may then be generated representing both the object to be printed and the supporting frame. The pre-print application may generate slices of the modified model data which may be sent to the printer for print data generation. Alternatively, the slices of the modified model may be extracted within the printer itself to generate printer control data. During 3D printing, the object and supporting frame may be generated by the 3D printer.

After printing is completed the printed parts may undergo cooling, and may then undergo post-processing. As described above, post-processing may include removal of excess powder in the case of a powder-based 3D printing process, and may include chemical polishing in a chemical polishing chamber. The printed parts may then be removed from the chamber and detached from the supporting frame.

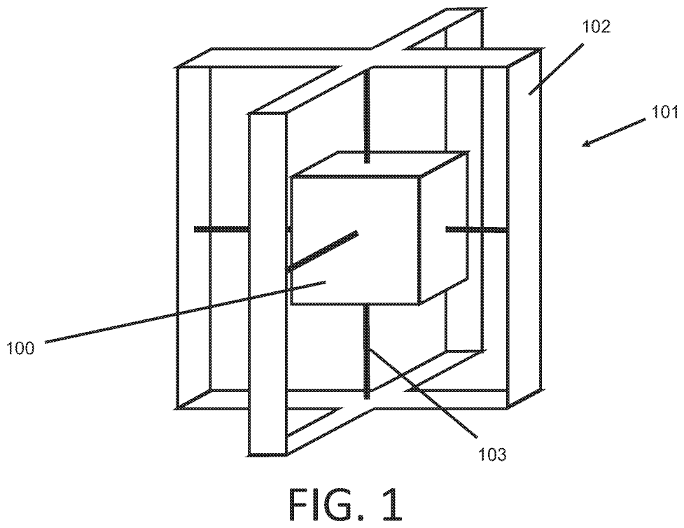

FIG. 1 shows schematically an example of a frame 101 that may be determined as part of the build data and printed to envelop an object 100, in order to support the object during post-processing. In this example, the frame comprises a base portion 102 and a plurality of branches 103 connecting the frame base portion to the object. In this example five branches are depicted, but the disclosure is not limited to this number only. The dimensions of the frame 101, including the number and dimensions of the branches, may be determined automatically in such a way that the frame and branches are able to support the weight of the object, but use a sufficiently small amount of material to enable the object to be suitably exposed during post-processing steps such as sandblasting or chemical polishing, in order to increase the effectiveness of such processes. In particular, the number and dimensions of the branches may be determined automatically in accordance with the dimensions of the object, based on the model of the object, such that they may withstand post-processing stages. The dimensions of the branches may be determined such that the branches are weakened during post-processing, for example during chemical polishing, but do not break. By determining the dimensions of the branches so as to be weakened during chemical polishing, for example, the object 100 may be more easily separated from the frame once post-processing is complete. In this manner, the printed object 100 may remain supported throughout the post-processing stages, whilst also enabling easy removal from the frame 101 afterwards.

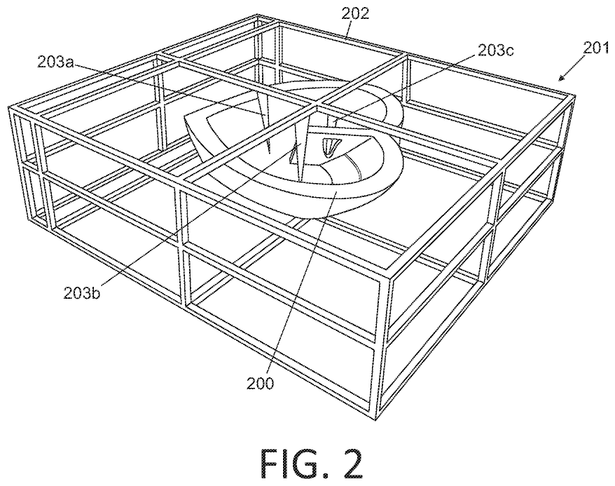

FIG. 2 shows a further example of a frame 201 that may be generated to envelop and support an object 200. In this example the frame 201 comprises a base portion 202, which has a cage, or lattice, structure, and which supports the object 200 while still adequately exposing the object for sandblasting or chemical polishing, for example. This example frame 201 also includes three branches 203a, 203b, 203c. These branches are positioned, in this example, such that the contact points of the branches on the object 200 are located in a region where concavities exist on the object. These are also positons of low aesthetic importance in the finished part, such that any artefacts remaining on the surface of the object following detachment of the object from the branches are not located in areas of visual significance and therefore do not require further manual finishing by an operator. Areas of low aesthetic importance may be specified in the object model data, or may be manually specified by an operator, or may be determined automatically based on detected parameters of the object (for example, areas of concavity in the object surface), and the positioning of the branches may be determined on the basis of this information.

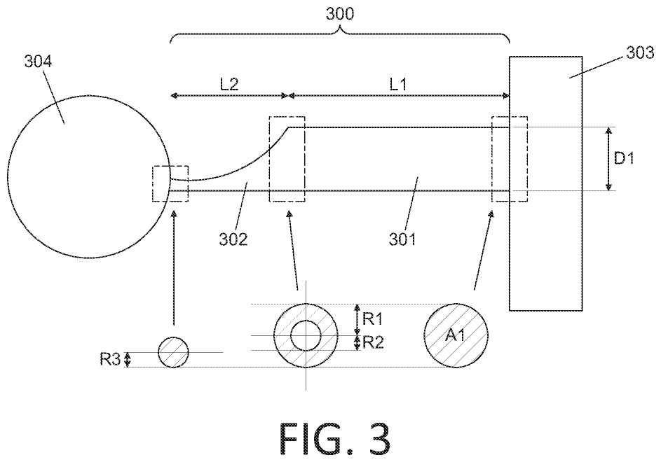

FIG. 3 shows another example of a branch 300 for connecting the part(s) to the frame. In this example, the branch 300 comprises a base portion 301 and a tapered connector portion 302. The base portion 301 is connected to the frame base portion 303, and the connector portion 302 is connected to the object 304. FIG. 3 further illustrates cross-sections of the branch 300 at various points along its length, namely: (i) at a junction between the object 304 and the connector portion 302; (ii) at a junction between the connector portion 302 and the base portion 301 of the branch 300; and (iii) at a junction between the base portion 301 of the branch and the frame base portion 303.

The base portion 301 may be designed in such a way that it acts as a robust link between the frame base portion 303 and the connector portion 302 of the branch 300. The base 301 may have a broad support area, as shown in this example by the base portion 301 having a cylindrical shape having a circular cross-section of diameter D1, resulting in contact area A1 with the frame base portion 303 which is sufficient to secure the branch 300 to the frame during handling and post-processing. In this example, the base portion 301 is fully defined by parameters representing its length L1 and diameter D1. Other configurations and cross-sectional shapes may be used for the base portion 301.

In some examples, the connector portion 302 may be determined in such a way that it is robust against post-processing methods, but still allows easy removal of the object 304 afterwards with minimal aesthetic impact on the surface of the object. In the example of FIG. 3, the connector portion 302 has a circular cross-section with a diminishing radius so that a radius R3 of the connector portion at a junction with the object 304 is smaller than a radius R1 at a junction with the base portion 301 of the branch 300. The reduced contact area of the connector portion at the junction with the object 304 minimizes the aesthetic impact of the joint after frame removal whilst also enabling more easy removal of the object from the frame. In this example, the connector 302 also has a concave curved transition between radius R1 and radius R3, in order that the connector portion 302 approaches the junction with the object 304 at an angle closer to perpendicular with the abutting surface of the object. This arrangement may further facilitate removal of the object 304 from the connector portion 302 following post-processing. In the illustrated example, the transition between radius R1 and radius R3 of the connector is defined by a continuous curve. In some examples, such as the arrangement shown in FIG. 3, the connector portion 302 may be hollow, having a non-fused core such that it is defined at the junction with the base portion 301 by an outer radius R1 and an inner radius R2. In this case, the non-fused core tapers towards the junction with the object 304, such that the inner radius diminishes to zero as the connector portion tapers towards the object 304. In other examples, the connector portion may not be tapered, and the branch may comprise a base portion having a first cross-sectional area and a connector portion having a second, smaller cross-sectional area.

In some examples, the parameters defining the shape of the base portion 301 and connector portion 302 of the branch 300 may be set via dynamic computation of the strength of the branch as a function of these parameters, in order to ensure sufficient strength to support the mass of the object, which may be specified in the object model, or determined on the basis of object dimensions derived from the object model. This may entail determining parameters of the base portion and connector portion that would provide sufficient support for the object 304 during the post-processing stages. The mass of the branch itself may also be dynamically computed as a function of the parameters defining the shape of the branch, and a minimisation of this function may be performed in order to determine parameters of the branch which provide sufficient strength to support the object, with minimal material used to produce the branch. In some examples, the parameters of each branch may be determined in such a way as to minimize the number of branches 300 required to support the object 304. Minimising the number of branches may increase the exposure of the object to processes such as chemical polishing during post-processing, which may thereby increase the effectiveness of such processes, and may also facilitate the detachment of the frame from the object by minimising the number of attachment points, which may reduce operator time required for such detachment.

In some examples, one or more of the branches may comprise a single base portion having multiple connector portions extending from it. Each of these multiple connector portions may have the properties of the single connector portion described above, and may have independent parameters determined for each respective connector portion to support the object or respective objects.

In some examples, the attachment locations and number of the branches may be determined based on, for example, a determination of the mass and/or center of mass of the object. For example, a determination of the mass of the object may be made based on the dimensions of the object specified in the object model data, and the number of branches may be determined in proportion with the mass of the object, in order to provide sufficient support for the object. In an example, the center of mass of the object may be determined from the object model data, and the attachment location(s) of the branch(es) on the object may be determined in such a way as to increase the stability of the support provided by the branches. For example, the locations of the branches may be determined relative to the center of mass so as to reduce torsional load on the branches at the attachment points when the object is supported by the frame, and for example, the attachment locations may be determined such that the center of mass lies between the attachment points.

In some examples, the object model data comprises multiple parts to be generated, and the determination of the frame is made in accordance with the requirement to envelop and support all of the parts simultaneously.

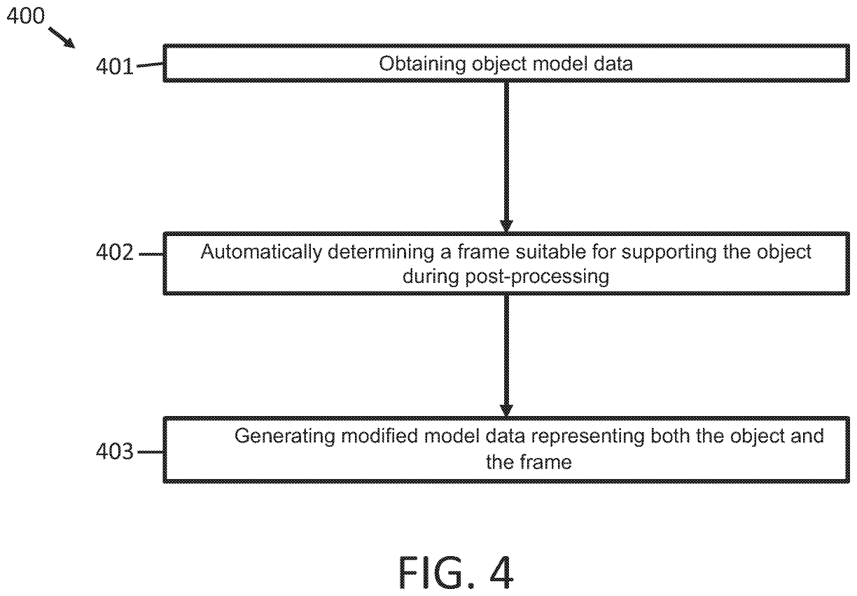

FIG. 4 shows an example of a method 400 for generating printer control data comprising build data to control a 3D printer to generate an object and a supporting frame. The method comprises obtaining 401 object model data defining an object to be generated by a three-dimensional printer; and determining 402 a frame suitable for supporting the object during post-processing of the generated object. In some examples, the frame comprises a frame base portion and one or more branches connecting the object to the frame base portion. In some examples, determining the frame comprises determining contact location(s) on the object for the one or more branches, and determining the position of the frame based on the contact location(s). In some examples, the dimensions and position of the frame base portion and the one or more branches are determined so as to be able to withstand post-processing steps of sand-blasting and/or chemical polishing of the object, while continuing to support the object.

At 403, modified model data is generated, representing both the object and the frame. This modified model data may be used to generate slices in a pre-print application which may then be transmitted to a 3D printer, or extracted within the printer itself.

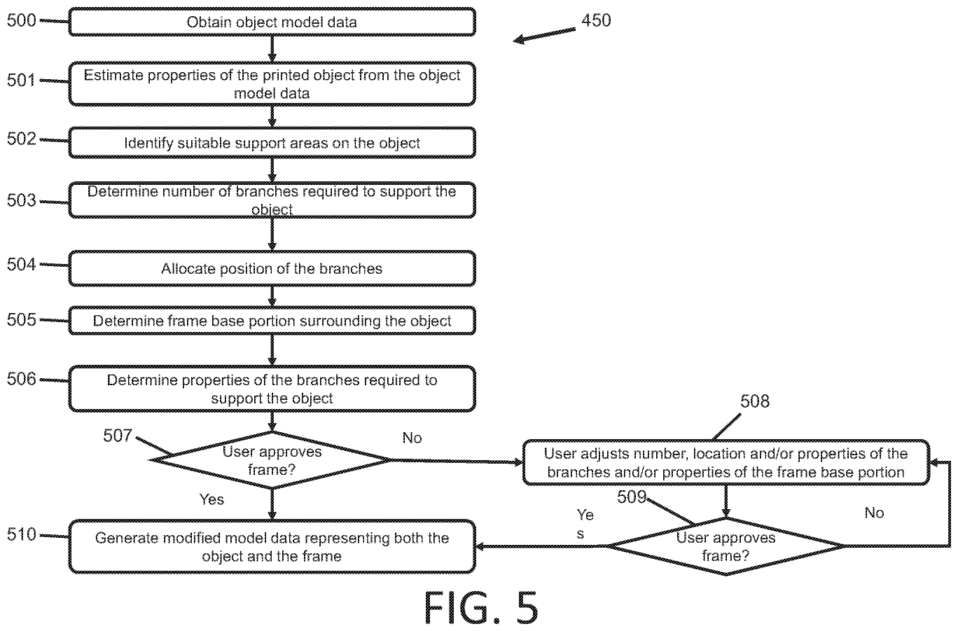

FIG. 5 shows a further example of a method 450 for generating printer control data comprising build data to control a 3D printer to generate an object within a frame. The method comprises obtaining 500 object model data defining one or more objects to be generated by a 3D printer. From this data, properties of the object when it is printed are estimated at 501, which may include, for example, the mass and/or center of mass of the or each object. These properties are used at 502 to identify suitable support areas on the object, at which one or more branches of the frame will be attached to the object when the frame and object are printed. Suitable support locations may be determined based on the estimated center of mass of the object, for example. Information about regions of the object which are of low aesthetic importance may also be taken into consideration, and such information may be manually specified by an operator, specified in the object model data, or determined automatically based on detected parameters of the object. At 503, the number of branches required to support the object is determined, and this determination may be based on a known or estimated mass of the object. The number of branches may be minimised in order to minimally impede the exposure of the object to post-processing procedures such as chemical polishing, as well as facilitating detachment of the frame from the object following post-processing. At 504, the positions of the determined branches are allocated and at 505 the frame base portion is determined so as to surround the object, based on the locations of the branches. The frame base portion may comprise a cage or lattice around the object, and the position of components making up the frame base portion may be such as to minimise the distance between the object and the frame base portion in proximity to the attachment locations, in order to minimise the length of the branches and thereby increase the stability of the structure. By determining the position and geometry of the frame base portion based on suitable attachment locations determined on the surface of the object, a robust supporting frame may be determined. In one example, the frame base portion is determined such that the branches extend perpendicularly from the frame base portion to the object.

At 506, properties of the branches are determined so that the object will be supported during post-processing steps. These properties may include the geometrical parameters of the branches, described above with reference to FIG. 3. The properties of the branches may be determined such that the branches will sufficiently weaken during post-processing, for example during chemical polishing, that the object can subsequently be easily detached. At 507 the user is given the opportunity to approve the determined frame. If the user approves the determined frame, then at 510 the modified model data is generated on the basis of the determined frame, and a print job may then be submitted to the 3D printer. If, at 507, the user does not approve the determined frame, then the user may adjust parameters of the frame at 508, such as the number, location and/or properties of the branches, and/or the properties of the frame base portion. Such adjustment continues until, at 509, the user approves the adjusted frame, and the modified model data is generated at 510 representing both the object and the adjusted frame.

When determining the structure of the frame, a number of constraints may be satisfied in order to increase the effectiveness of the frame, and these may include, but are not limited to, any or all of:

(i) reducing the number of branches and/or the surface area of the frame base portion, while retaining sufficient strength to support the object, in order to facilitate exposure of the object to post-processing steps such as sandblasting and/or chemical polishing, as well as reducing the additional material used to produce the frame;

(ii) providing the frame with sufficient strength and with geometry suitable to at least partially surround the object or objects to enable printed objects to be handled and stacked in a post-processing chamber without printed objects touching one another, whether printed objects are supported by separate respective frames, or multiple objects are supported by a single frame;

(iii) providing sufficient branches to support the object in a robust way, while minimising the number of branches to facilitate detachment of the object from the frame;

(iv) determining junctions between branches and the object in areas of the object determined or specified to have low aesthetic importance.

In some examples, suitable contact areas, reflecting possible locations on the object where the branches may be connected, may be identified either manually, automatically or a combination of both. For example, suitable contact areas may be identified in accordance with regions of higher or lower curvature, or regions where concavities or convexities exist in the object surface.

It should be understood that FIG. 5 illustrates an example method for the determination of a frame supporting a 3D printed object and generation of printer control data, and includes one example of user input. In some examples, the user may have the opportunity to input variables at various stages of the method. For instance, in some examples the user may input or adjust the of the support area locations, number of branches, position of branches, properties of branches, and/or properties of the frame base portion.

In some examples, the determination of the properties and locations of the branches and frame base portion may take place in a different order from that shown in FIG. 5. For example, properties of the frame base portion may be determined before the branches and their location. In some examples, machine learning may be implemented so that the system learns from previously determined frame(s) and applies the properties to future builds. In one application of this, the system may apply the properties to a number of identical builds so that the object can be mass produced without the need for individual approval by a user.

It is to be understood that the determination of the frame, and the number and location of the branches, may be made in accordance with any of the above described methods. This determination may be made automatically, manually, or a combination of the two, for example by providing an automated determination and using a user input to modify the automated determination.

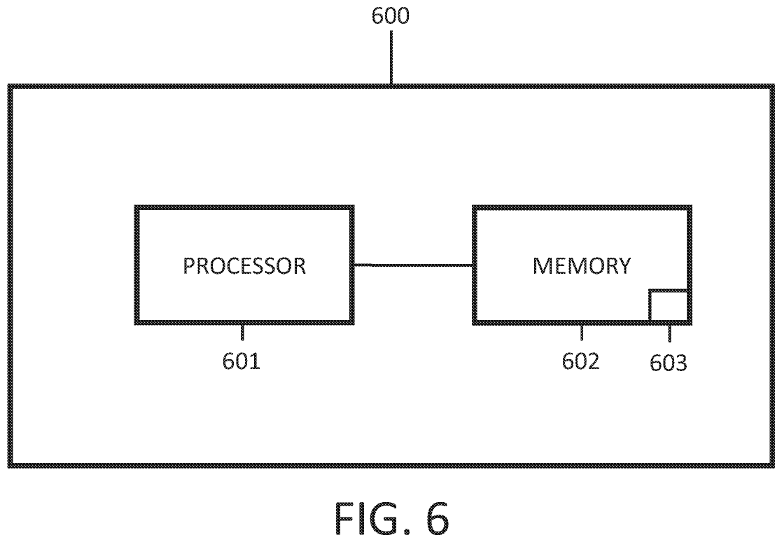

FIG. 6 shows an example of a controller 600 configured to generate printer control data. The controller 600 comprises a processor 601 and a memory 602. Stored within the memory 602 are instructions 603 for generating printer control data according to any of the examples described above. In one example, the controller 600 may be part of a computer running the instructions 603. In another example, the controller 600 may be part of a 3D printer configured to run the instructions 603 after obtaining object model data.

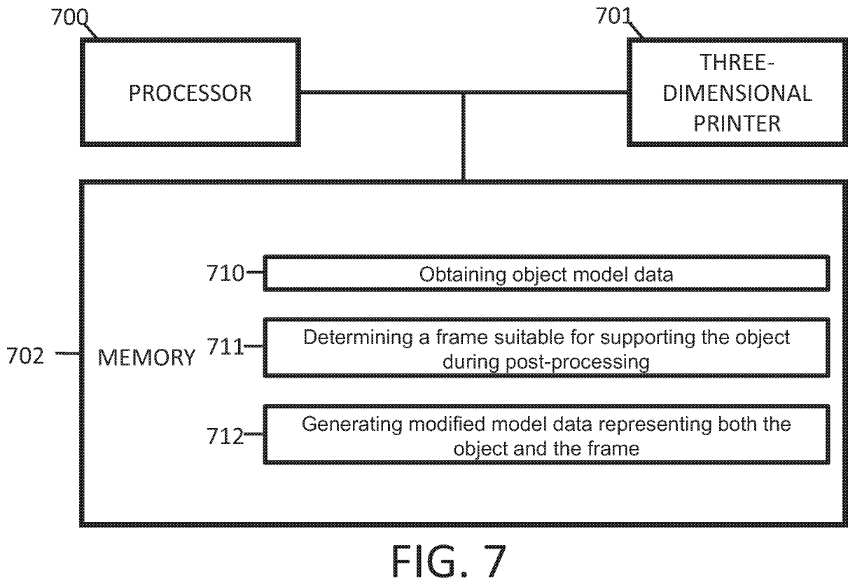

FIG. 7 shows a memory 702, which is an example of a computer readable medium storing instructions 710, 711, 712 that, when executed by a processor 700 communicably coupled to an additive manufacturing system, in this case a 3D printer 701, cause the processor 700 to generate printer control data in accordance with any of the examples described above. The computer readable medium 703 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

1. A method comprising:
obtaining object model data defining an object to be generated by a three-dimensional printer;
automatically determining a frame suitable for supporting the object during post-processing of the generated object, wherein the frame comprises:
a frame base portion; and
one or more branches connecting the object to the frame base portion;
wherein the position and/or dimensions of the frame are determined in accordance with dimensions of the object, based on the object model data;
the method further comprising:
generating modified model data representing both the object and the frame, for generation by the three-dimensional printer.

2. The method of claim 1, wherein the frame is arranged to envelop the object.

3. The method of claim 1, wherein determining the frame comprises:
(i) determining contact location(s) on the object for the one or more branches; and
(ii) determining the position of the frame base portion based on the contact location(s).

4. The method of claim 3, wherein the position of the frame base portion is determined based on a determination of the mass and/or the center of mass of the object.

5. The method of claim 1, wherein each of the one or more branches comprises a base portion and a tapered connector portion, the base portion being connected to the frame base portion, and the connector portion being connected to the object.

6. The method of claim 5, wherein at least one of the branches comprises a base portion and more than one connector portion.

7. The method of claim 5, wherein the connector portion is hollow.

8. The method of claim 5, wherein the connector portion of each branch has a diminishing cross-sectional radius so that a first radius of the connector portion at a junction with the object is smaller than a second radius at a junction with the base portion of the branch.

9. The method of claim 8, wherein a transition between the first and second radius is curved.

10. The method of claim 1, wherein the object model data defines more than one object to be generated, and the frame is arranged to support and envelop all of the objects.

11. The method of claim 1, wherein properties of the automatically determined frame are updateable via user input.

12. A system comprising a controller configured to:
obtain object model data defining an object to be generated by an additive manufacturing system;
obtain frame model data defining an automatically determined frame suitable for supporting the object during post-processing of the generated object, wherein the frame comprises:
a frame base portion; and
one or more branches connecting the object to the frame base portion;
wherein the position and/or dimensions of the frame are determined in accordance with dimensions of the object, based on the object model data;
and the system is further configured to:
generate modified model data representing both the object and the frame, for generation by the additive manufacturing system.

13. The system of claim 12, wherein obtaining the frame model data comprises:
(i) determining contact location(s) on the object for the one or more branches; and
determining the position of the frame base portion based on the contact location(s).

14. The system of claim 13, wherein the position of the frame base portion is determined based on a determination of the mass and/or the center of mass of the object.

15. A computer-readable medium comprising instructions that, when executed by a processor communicably coupled to an additive manufacturing system, causes the processor to:
obtain object model data defining an object to be generated by a three-dimensional printer;
obtain a frame model defining an automatically determined frame for supporting the object during post-processing, wherein the frame comprises:
a frame base portion; and
one or more branches connecting the object to the frame base portion;
wherein the position and/or dimensions of the frame are determined in accordance with dimensions of the object, based on the object model data; and
generate modified model data representing both the object and the frame.
